(19) United States
(12) Patent Application Publication
(10) Pub. No.: US 2006/0208402 A1
(43) Pub. Date: Sep. 21, 2006

(54) Air spring protector

(75) Inventors: Christopher S. Keeney, Troy, MI (US); Edward J. Eshelman, Rochester Hills, MI (US); Christine L. Lutz, Birmingham, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/373,471

(22) Filed: Mar. 10, 2006

Related U.S. Application Data
(60) Provisional application No. 60/663,951, filed on Mar. 21, 2005.

(51) Int. Cl. F16F 5/00

(52) U.S. Cl. 267/64.11; 267/64.15

(57) ABSTRACT

An air spring for a vehicle suspension includes a resilient spring body that is surrounded by a protective cover. The protective cover protects the resilient spring body from rupturing when used in harsh vehicle conditions. Preferably, the protective cover is comprised of a rigid or flexible armor material that is resistive to munitions, such as projectiles and razor wire, for example.

### RELATED APPLICATIONS

This application claims priority to a U.S. provisional application serial No. 60/663,951 filed on Mar. 21, 2005.

### TECHNICAL FIELD

This invention generally relates to a protective cover for an air spring in a vehicle suspension.

### BACKGROUND OF THE INVENTION

Vehicle suspensions utilize components such as springs and shock absorbers to improve vehicle ride characteristics by accommodating variations in road surfaces. There are many different types of vehicle suspensions including mechanical suspensions and air suspensions. Mechanical suspensions utilize components such as leaf springs, for example, while air suspensions utilize air springs.

Air suspensions provide improved performance characteristics compared to traditional mechanical suspensions. Air suspensions offer improved mobility and ride characteristics, as well as providing many beneficial functions that cannot be accommodated by mechanical suspensions. Due to these improved performance characteristics, air suspensions have been widely adopted in commercial vehicle markets.

However, air suspensions have not traditionally been utilized for harsh condition or severe duty applications such as military applications, for example. One concern with air suspensions in these types of applications is air spring integrity. The air springs are typically made from a resilient material, such as rubber for example, which could be susceptible to rupturing. Munitions or other military obstacles, such as razor wire for example, could snag or pierce the air spring causing the air spring to deflate, which consequently adversely affects suspension performance.

For the above reasons, it would be desirable to provide an air suspension with air springs that are protected from harsh external environments.

### SUMMARY OF THE INVENTION

An air spring for a vehicle suspension utilizes a protective cover to prevent the air spring from rupturing when used in harsh vehicle operating conditions. The air spring includes a resilient spring body that is mounted between a vehicle structure and a suspension component, such as a control arm. The protective cover is preferably comprised of an armor material that is resistive to penetration by projectiles, and which is resistive to being slashed or cut by sharp objects.

In one example, the protective cover is comprised of a rigid material that surrounds the resilient spring body. A flexible connection extends between the air spring and the protective cover to allow rebound and extension movement of the resilient spring body. The protective cover can be made from a single piece or can be made from multiple pieces that are secured together.

In another example, the protective cover is comprised of a flexible material that surrounds the resilient spring body. The flexible material allows the protective cover to expand and contract in response to movement of the resilient spring body.

In addition to providing protection from rupturing under harsh external environmental conditions, the protective cover can provide jounce and/or rebound travel limiting functionality. This can be achieved by designing the protective cover to constrain outward movement and/or extension length of the resilient spring body. This goal can be achieved with either a rigid or flexible protective cover. These and other features of the present invention can be best understood from the following specification and drawings, the following of which is a brief description.

### BRIEF DESCRIPTION OF THE DRAWINGS

FIG. 1 is a schematic view of an air spring and protective cover mounted in a vehicle suspension.

FIG. 2 is one example of an air spring and protective cover incorporating the subject invention in a first position.

FIG. 3 shows the air spring of FIG. 2 in a second position different from the first position.

FIG. 4 is another example of an air spring and protective cover incorporating the subject invention in a first position.

FIG. 5 shows the air spring of FIG. 4 in a second position different from the first position.

FIG. 6 is another example of a protective cover incorporating the subject invention.

FIG. 7 is another example of an air spring and protective cover incorporating the subject invention in a first position.

FIG. 8 shows the air spring of FIG. 7 in a second position different from the first position.

FIG. 9 is another example of an air spring and protective cover incorporating the subject invention.

FIG. 10 shows the protective cover of FIG. 9 completely surrounding the air spring and being secured with clamps.

### DETAILED DESCRIPTION OF THE PREFERRED EMBODIMENT

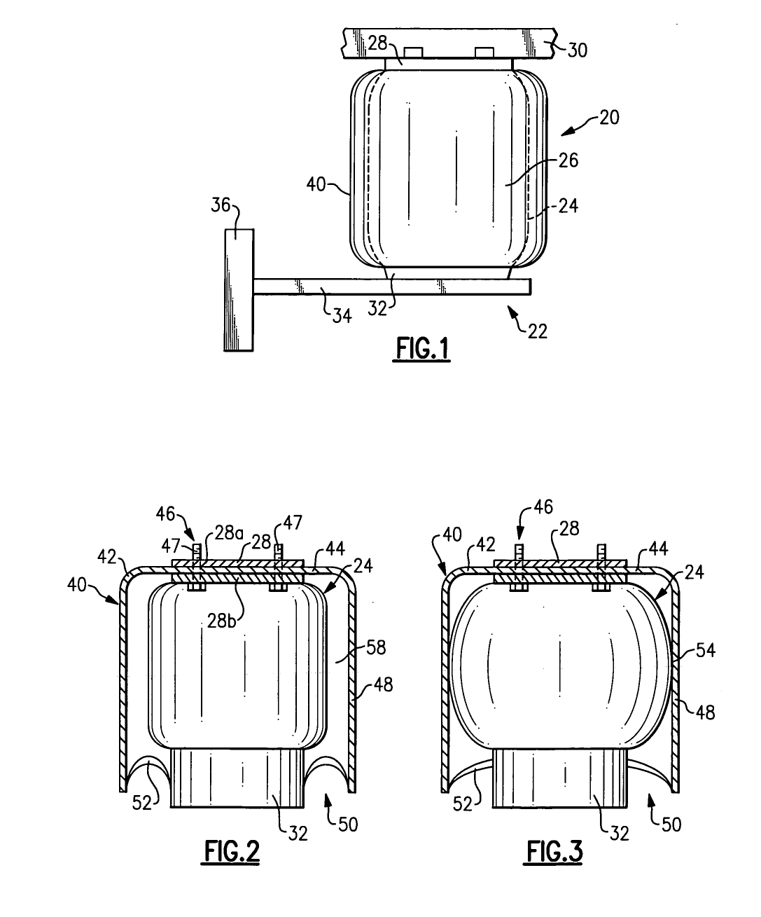

An air spring 20 for a vehicle suspension 22 is shown in FIG. 1. The air spring 20 includes a resilient spring body 24 that defines an inner cavity 26. The inner cavity 26 is filled with air as known. The resilient spring body 24 is preferably made from a rubber material, however, other resilient materials could also be used to form the resilient spring body 24.

A first support 28 is used to mount the air spring 20 to a vehicle structure 30, such as a vehicle frame member, for example. A second support 32 is used to mount the air spring 20 to a suspension component 34. In the example shown in FIG. 1, the suspension component 34 preferably comprises a control arm that is supported by a vehicle wheel component shown schematically at 36. The control arm is preferably utilized in an independent suspension, however, it should be understood that an air spring 20 designed according to the subject invention could be used in any type of air suspension. Further, the air spring 20 could also be supported by suspension components other than a control arm.

The air spring 20 includes a protective cover 40 that substantially surrounds the resilient spring body 24. The protective cover 40 can be made from a rigid or flexible material. In the examples shown in FIGS. 2-6, the protective cover 40 is made from a rigid armor material such as steel, Kevlar®, or a composite material for example. Other armor materials could also be used to form the protective cover 40, however, the material should be resistive to rupturing due to munitions or other military obstacles, such as razor wire for example.

In FIG. 2, the protective cover 40 comprises a rigid cover 42 that is cup-shaped. The rigid cover 42 includes a base portion 44 that is rigidly connected to the first support 28 at a connection interface 46, and a wall portion 48 that extends from the base portion 44 to surround the resilient spring body 24. The base portion 44 covers one end of the resilient spring body 24 and the wall portion 48 surrounds an outer circumference of the resilient spring body 24. The rigid cover 42 includes an open end 50 adjacent the second support 32.

In the example shown, the connection interface 46 is comprised of a plurality of fasteners 47, such as bolts for example. The first support 28 includes a first portion 28a that is positioned on one side of the base portion 44 and a second portion 28b that is positioned on an opposite side of the base portion 44, such that the base portion is directly sandwiched between the first 28a and second 28b portions. The first 28a and second 28b portions are preferably formed as rigid plates. This provides a rigid, fixed, and secure connection interface 46 to the vehicle structure 30 (FIG. 1).

A flexible connection 52 extends between the second support 32 and the wall portion 48 of the rigid cover 42. The flexible connection 52 accommodates suspension articulation. The flexible connection 52 can be made from a flexible steel mesh, however, other materials could also be used. The flexible connection 52 encloses the open end 50 of the rigid cover 42 to further protect an underside of the resilient spring body 24. The flexible connection 52 could also provide rebound travel limiting functionality by being designed to become taut at an extreme rebound position.

When not subjected to a suspension load, or when operating under normal loading operations, the rigid cover 42 is separated from the outer circumference of the resilient spring body 24 by a gap 58. The flexible connection 52 could provide jounce and/or rebound travel limiting functionality by designing the rigid cover 42 to constrain the resilient spring body 24, as the resilient spring body 24 bulges out in a jounce mode as shown at 54 in FIG. 3.

The configuration shown in FIGS. 2-3 is just one example of a flexible connection 52. It should be understood that the flexible connection 52 could have other configurations including being positioned at other locations within the rigid cover 42. Also, additional flexible connections 52 could be incorporated into the air spring 20, if necessary depending upon vehicle applications.

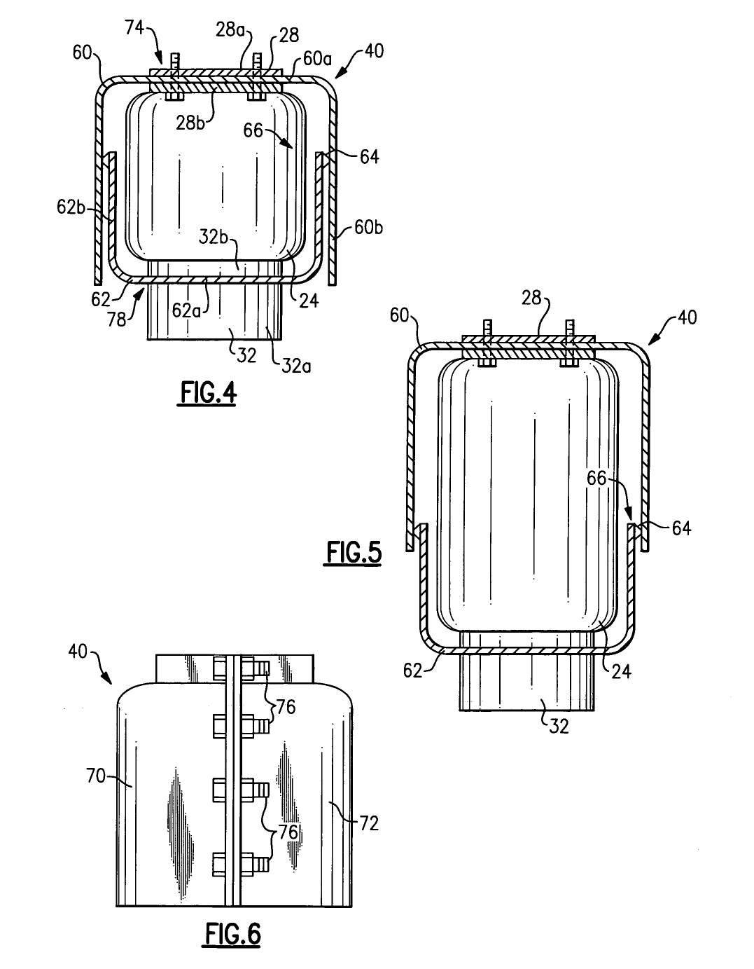

Another example of a protective cover 40 is shown in FIGS. 4-5. In this example, the protective cover 40 includes a first portion 60 and a second portion 62 that at least partially overlap each other. This overlapping relationship allows relative sliding movement between the first 60 and second 62 portions between a retracted position (FIG. 4) and an extended position (FIG. 5).

The first portion 60 is rigidly connected to the first support 28 and the second portion 62 is rigidly connected to the second support 32. The first portion 60 is cup-shaped with a base portion 60a and a wall portion 60b that extends from the base portion 60a to surround the resilient spring body 24. The base portion 60a is rigidly connected to the first support 28 at a connection interface 74. The first support 28 includes first 28a and second 28b portions as discussed above. The base portion 60a is directly sandwiched between the first 28a and second 28b portions to provide a rigid, fixed, and secure connection interface 74 to the vehicle structure 30 (FIG. 1).

The second portion 62 is also cup-shaped with a base portion 62a and a wall portion 62b that extends from the base portion 62a to surround the resilient spring body 24. The base portion 62a is rigidly connected to the second support 32 at a connection interface 78. The second support 32 includes a first portion 32a positioned on one side of the base portion 62a, and a second portion 32b positioned on an opposite side of the base portion 62a. The base portion 62a is directly sandwiched between the first 32a and second 32b portions to provide a rigid, fixed, and secure connection interface 78 to the suspension component 34 (FIG. 1). Any type of connecting mechanism can be used to for the connection interfaces 74, 78, such as a bolted joint for example (only shown for connection interface 74).

In this configuration, upper and lower ends, as well as the side wall of the resilient spring body 24, are enclosed by the protective cover 40. Rebound and extension movement of the resilient spring body 24 is accommodated by a sliding interface 66 between the first 60 and second 62 portions. An optional seal and/or friction bearing 64 is provided between the first 60 and second 62 portions at the sliding interface 66. It should be understood that while the example shown in FIGS. 4-5 has the second portion 62 is received within the first portion 60, the reverse configuration could also be used.

Another embodiment of the protective cover 40 is shown in FIG. 6. In this example, the protective cover 40 includes a first half 70 and a second half 72 that are fastened together to surround the resilient spring body 24. The first 70 and second 72 halves are made from a flexible impenetrable armor material such as ballistic nylon, Kevlar®, or a stainless steel mesh material for example. Optionally, the protective cover 40 could be made from a rigid armor material as described above, with an open end such as that shown in FIGS. 2-3 with a flexible connection 52.

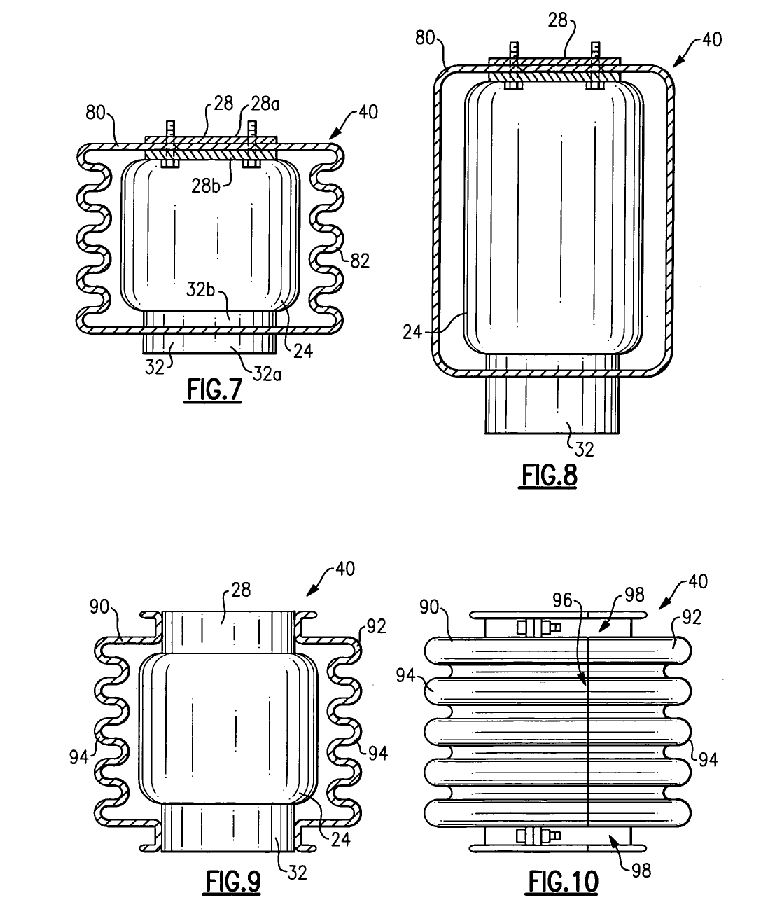

In the example shown, the first 70 and second 72 halves are fastened together with a plurality of bolts 76, however other types of fasteners or attachment interfaces could also be used. One of the benefits of the example shown in FIG. 7 is that the first 70 and second 72 halves of the protective cover 40 are easily separated to facilitate maintenance or to reduce weight when the vehicle is not being subjected to harsh external environments.

In FIGS. 7-8, the resilient spring body 24 is enclosed within a flak jacket 80 that has an accordion body portion 82. One portion of the flak jacket 80 is connected to the first support 28 and another portion of the flak jacket 80 is connected to the second support 32. The first 28 and second 32 supports have first 28a, 32a and second portions 28b, 32b that sandwich the flak jacket 80 in a manner similar to that described above.

The accordion body configuration provides compact packaging and extension characteristics. The accordion body portion 82 is movable between a collapsed position (FIG. 7) and an extended position (FIG. 8) where the accordion body portion 82 is taut. The flak jacket 80 can be designed to provide jounce and/or rebound travel limiting functionality by achieving a taut position at a corresponding extreme position of travel.

Another example of a protective cover 40 is shown in FIGS. 9-10. In this example, the resilient spring body 24 is enclosed within a flak jacket having first 90 and second 92 flak jacket portions that are clamped together. The flak jacket includes an accordion body portion 94 similar to that described above.

The first 90 and second 92 flak jacket portions overlap each other at a seam portion 96 to provide a tight seal. At least one clamp 98 is used to hold the first 90 and second 92 flak jacket portions together. Any type of clamp can be used including a hose clamp, for example.

In the example shown in FIG. 10, the first 90 and second 92 flak jacket portions are formed as a one-piece flak jacket with one seam portion 96. A first clamp 98 is used to secure an upper portion of the flak jacket to the first support 28 and a second clamp 98 is used to secure a lower portion of the flak jacket to the second support 32. While a one-piece flack jacket is shown as including first 90 and second 92 flak jacket portions with a single seam portion 96, it should be understood that the first 90 and second 92 flak jacket portions could also be separate pieces having two seam portions 96 that are clamped together.

One of the benefits of the example shown in FIGS. 9-10 is that the first 90 and second 92 flak jacket portions of the protective cover 40 are easily separated to facilitate maintenance or to reduce weight when the vehicle is not being subjected to harsh external environments.

In the examples shown in FIGS. 7-10, the protective cover 40 is made from a flexible impenetrable armor material such as ballistic nylon, Kevlar®, or a stainless steel mesh material for example; however, other flexible impenetrable materials could also be used to form the protective cover 40. The accordion shape shown for the examples of FIGS. 7-10 is just one example shape, and it should be understood that other expandable shapes could also be used.

Further, it should be understood that the protective covers 40 shown in FIGS. 2-10 are just a few examples of different cover configurations. The disclosed protective cover 40 could also be formed to have other shapes or sizes.

Finally, the protective cover 40 is made from armor or other impenetrable materials, which can be either rigid or flexible, but which are resistive to penetration by a ballistic projectile such as a bullet or missile, for example. This allows a more beneficial air suspension to be utilized in harsh environment vehicle applications.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An air spring for a vehicle suspension comprising:
a resilient spring body to be supported on a suspension component; and
a protective cover substantially surrounding said resilient spring body.

2. The air spring according to claim 1 wherein said protective cover comprises a rigid cover.

3. The air spring according to claim 2 wherein said rigid cover is formed from an armor material comprising at least one of a steel material, Kevlar® material, and a composite material.

4. The air spring according to claim 2 including a flexible connection extending between the air spring and said rigid cover to accommodate suspension articulation.

5. The air spring according to claim 4 wherein said flexible connection comprises a flexible steel mesh.

6. The air spring according to claim 2 including a first support adapted to connect said resilient spring body to a vehicle frame member and a second support adapted to connect said resilient spring body to the suspension component and wherein said rigid cover includes a first cover portion mounted to said first support and a second cover portion mounted to said second support, said first and second cover portions being positioned in overlapping relationship such that at least one of said first and second cover portions can slide relative to the other of said first and second cover portions.

7. The air spring according to claim 2 wherein said rigid cover includes a first portion and a second portion that are fastened together to surround said resilient spring body.

8. The air spring according to claim 1 including a first support adapted to connect said resilient spring body to a vehicle frame member and a second support adapted to connect said resilient spring body to the suspension component wherein said protective cover is rigidly connected to said first support.

9. The air spring according to claim 1 wherein said protective cover comprises a flexible cover.

10. The air spring according to claim 9 including a first support adapted to connect said resilient spring body to a vehicle frame member and a second support adapted to connect said resilient spring body to the suspension component wherein said flexible cover includes a first end fixed to said first support and a second end fixed to said second support.

11. The air spring according to claim 9 wherein said flexible cover is formed from an impenetrable material comprising at least one of a ballistic nylon material, Kevlar® material, and a stainless steel mesh material.

12. The air spring according to claim 9 wherein said flexible cover includes an expandable body portion that is movable between a taut position and a collapsed position to accommodate suspension extension.

13. The air spring according to claim 9 wherein said flexible cover includes at least a first portion and a second portion that are clamped together to surround said resilient spring body.

14. The air spring according to claim 13 wherein said first and second portions overlap each other to form a seam portion.

15. The air spring according to claim 13 wherein said first and second portions form a one-piece flak jacket that completely surrounds said resilient spring body.

16. The air spring according to claim 1 wherein the suspension component comprises a control arm for an independent suspension.

17. The air spring according to claim 1 wherein said resilient spring body includes an internal cavity filled with air.

18. The air spring according to claim 1 wherein said protective cover comprises an armor material that is resistive to penetration by ballistics.

19. The air spring according to claim 1 wherein said protective cover is selectively attachable to and detachable from the air spring without having to disassemble the air spring from a vehicle.
